(19) United States
(12) Patent Application Publication
(10) Pub. No.: US 2013/0141327 A1
(43) Pub. Date: Jun. 6, 2013

(54) GESTURE INPUT METHOD AND SYSTEM

(71) Applicant: Wistron Corp., New Taipei City (TW)

(72) Inventors: Shou-Te Wei, New Taipei City (TW); Chia-Te Chou, New Taipei City (TW); Hsun-Chih Tsao, New Taipei City (TW); Chih-Pin Liao, New Taipei City (TW)

(73) Assignee: WISTRON CORP., New Taipei City (TW)

(21) Appl. No.: 13/692,847

(22) Filed: Dec. 3, 2012

(30) Foreign Application Priority Data
Dec. 5, 2011 (TW) 100144596

(51) Int. Cl. G06F 3/01

(52) U.S. Cl. CPC G06F 3/011
USPC 345/156

(57) ABSTRACT

A gesture input method is provided. The method is used in a gesture input system to control a content of a display. The method includes: capturing, by a first image capturing device, a hand of a user and generating a first grayscale image; capturing, by a second image capturing device, the hand of the user and generating a second grayscale image; detecting, by an object detection unit, the first and second grayscale images to obtain a first imaging position and a second imaging position corresponding to the first and second grayscale images, respectively; calculating, by a triangulation unit, a three-dimensional space coordinate of the hand according to the first imaging position and the second imaging position; recording, by a memory unit, a motion track of the hand formed by the three-dimensional space coordinate; and recognizing, by a gesture determining unit, the motion track and generating a gesture command.

### CROSS REFERENCE TO RELATED APPLICATIONS

This application claims priority of Taiwan Patent Application No. 100144596, filed on Dec. 5, 2011, the entirety of which is incorporated by reference herein.

### BACKGROUND OF THE INVENTION

1. Field of the Invention

The present invention relates to an input device, and in particular relates to a gesture input device, wherein the gesture input device mainly is applied to a system with a human-machine interface and based on a data operation process.

2. Description of the Related Art

The need for more convenient, intuitive and portable input devices have increased, as computers and other electronic devices have become more prevalent in our everyday life. A pointing device is one type of input device that is commonly used for interaction with computers and other electronic devices that are associated with electronic displays. Known pointing devices and machine controlling mechanisms include an electronic mouse, a trackball, a pointing stick and touchpad, a touch screen and others. Known pointing devices are used to control a location and/or movement of a cursor displayed on the associated electronic display. Pointing devices may also convey commands, e.g. location specific commands, by activating switches on the pointing device.

In some instances there is a need to control electronic devices from a distance, in which case a user cannot touch the device. Some examples of these instances are watching TV, watching videos on a PC, etc. One solution used in these cases is a remote control device. Recently, human gesturing, such as hand gesturing, has been suggested as a user interface input tool, which can be used even at a distance from the controlled device.

Existing elements (for example, an all in one (AIO) computer, a smart TV and other devices) which are controlled by using human gestures from a distance can be classified into two main categories. One is a two-dimensional image sensor, and another is a three-dimensional camera which supports three-dimensional images. The two-dimensional image sensor can only detect a motion vector of an extremity in an XY plane across the two-dimensional image sensor, but can not detect a motion of the extremity toward or away from the two-dimensional image sensor along a Z-axis direction, for example, the motion “push/pull”. Although the three-dimensional camera which supports three-dimensional images can calculate and obtain the depth information of the image, and then track a motion track of an extremity (e.g., a hand) in the three-dimensional space, the cost of the three-dimensional camera which uses structured light or time of flight and can support three-dimensional images, is high, and the architecture is large and integration thereof into other devices is difficult.

Taiwan Patent No. 1348127, discloses a probability distribution manner for selecting a number of sampling points randomly in a working space, which is used to detect the direction that a gesture moves by using complicated probability statistical analysis. Prior art patents, such as the master's thesis “Recognition of Two-Handed Gestures via Couplings of Hidden Markov Models” published on July 2007 by the Department of Computer Science and Information Engineering (CSIE) of the National Cheng Kung University, or “Depth Camera Technology (Passive)” published by the Industrial Technology Research Institute, disclose methods for recognizing gestures by recognizing the skin color of a hand. Furthermore, prior art patents, such as the master's thesis “Human-Machine Interaction Using Stereo Vision-based Gesture Recognition” published in 2009 by the Department of Computer Science and Information Engineering of the National Central University, disclose a neural network, being used to achieve the mapping model of aberrations and image depth for tracking and detecting gestures and actions. If the solution of using the skin color detection and recognition is adopted, the accuracy for recognizing the skin color is easily affected by variations of ambient illuminants. If the solution for establishing the mapping models of image depth in advance is adopted, two cameras must be placed in parallel to generate aberrations, before the nearest object may be selected as the object of the gesture. The mentioned solutions may result in mistakes or misjudgments.

Therefore, a gesture input method and system are provided. The gesture input system is provided at a low cost, accommodates the ergonomic requirements of users, and increases the convenience and ease for controlling a content of a display. The gesture input method and system used in the invention will not be affected by the light and shade of the ambient light, and will not establish the mapping models of image depth in advance, and further will not use complicated sampling probability statistical analysis. The gesture input method and system of the invention is a simple and practical gesture detection solution.

### BRIEF SUMMARY OF THE INVENTION

A detailed description is given in the following embodiments with reference to the accompanying drawings.

A gesture input method and system are provided.

In one exemplary embodiment, the disclosure is directed to a gesture input method. The gesture input method is used in a gesture input system to control a content of a display, wherein the gesture input system comprises a first image capturing device, a second image capturing device, an object detection unit, a triangulation unit, a memory unit and a gesture determining unit, and the display. The method comprises: capturing, by the first image capturing device, a hand of a user and generating a first grayscale image; capturing, by the second image capturing device, the hand of the user and generating a second grayscale image; detecting, by the object detection unit, the first and second grayscale images to obtain a first imaging position and a second imaging position corresponding to the first and second grayscale images, respectively; calculating, by the triangulation unit, a three-dimensional space coordinate of the hand according to the first imaging position and the second imaging position; recording, by the memory unit, a motion track of the hand formed by the three-dimensional space coordinate; and recognizing, by the gesture determining unit, the motion track and generating a gesture command corresponding to the recognized motion track.

In one exemplary embodiment, the disclosure is directed to a gesture input system. The gesture input system is coupled to a display, and comprises a first image capturing device, a second image capturing device, a processing unit and the display. The first image capturing device is configured to capture a hand of a user and generate a first grayscale image. The second image capturing device is configured to capture a hand of a user and generate a second grayscale image. The processing unit is coupled to the first image capturing device and the second image capturing device and comprises an object detection unit, a triangulation unit, a memory unit, and a gesture determining unit. The processing unit is coupled to the first image capturing device and the second image capturing device and configured to detect a first grayscale image and a second grayscale image to obtain a first imaging position and a second imaging position corresponding to the first and second grayscale images, respectively. The triangulation unit is coupled to the object detection unit and configured to calculate a three-dimensional space coordinate of the hand according to the first imaging position and the second imaging position. The memory unit is coupled to the triangulation unit and configured to record a motion track of the hand formed by the three-dimensional space coordinate. The gesture determining unit is coupled to the memory unit and configured to recognize the motion track and generate a gesture command corresponding to the recognized motion track.

### BRIEF DESCRIPTION OF THE DRAWINGS

The present invention can be more fully understood by reading the subsequent detailed description and examples with references made to the accompanying drawings, wherein:

FIG. 1 is an architecture diagram of a gesture input system according to an embodiment of the present invention;

FIG. 2 is a block diagram of a gesture input system 100 according to an embodiment of the present invention;

FIG. 3 is a schematic diagram illustrating the imaging positions corresponding to the first and second grayscale images according to an embodiment of the present invention;

FIGS. 4A˜4B are flow diagrams illustrating the gesture input method used in the gesture input system according to an embodiment of the present invention;

FIGS. 5A˜5C are schematic diagrams illustrating applications of the gesture input method and system according to an embodiment of the present invention; and

FIGS. 6A˜6C are schematic diagrams illustrating applications of the gesture input method and system according to an embodiment of the present invention.

### DETAILED DESCRIPTION OF THE INVENTION

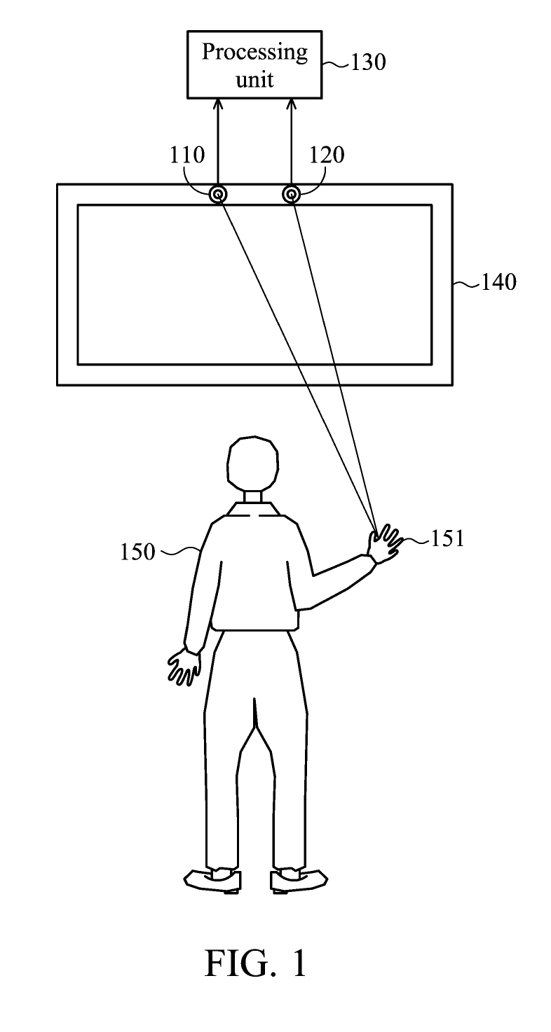

Several exemplary embodiments of the application are described with reference to FIG. 1 through FIG. 6C, which generally relate to a gesture input method and system. It is to be understood that the following disclosure provides various different embodiments as examples for implementing different features of the application. Specific examples of components and arrangements are described in the following to simplify the present invention. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The gesture input system of the present invention is a system with a human-machine interface, wherein the gesture input system is equipped with two image capturing devices. After capturing an extremity (for example, a hand of a user) by using the two image capturing devices, the gesture input system calculates imagings of an extremity image captured by the two image capturing devices by a processing unit to derive a three-dimensional space coordinate or a two-dimensional projection coordinate of the extremity in a space. The gesture input system records a motion track of the extremity according to information of the coordinates calculated by the processing unit to control a display.

Embodiments described below illustrate methods and systems for navigation of a movable platform of the present disclosure.

FIG. 1 is an architecture diagram of a gesture input system according to an embodiment of the present invention.

Referring to FIG. 1, the gesture input system comprises a first image capturing device 110, a second image capturing device 120, a processing unit 130 and a display 140. The display 140 can be a computer display, a personal digital assistant (PDA), a mobile phone, a projector, a television screen and so on. The first image capturing device 110 and the second image capturing device 120 can be two-dimensional cameras (for example, a closed circuit television (CCTV) camera, a digital video (DV), a web camera (WebCam) and so on). Under a condition that the first image capturing device 110 and the second image capturing device 120 can capture a hand 151 of a user 150, the first image capturing device 110 and the second image capturing device 120 can be placed in a position with an appropriate angle, but the first image capturing device 110 and the second image capturing device 120 do not have to be placed in parallel. In addition, the first image capturing device 110 and the second image capturing device 120 can also use different focal lengths. Before the first image capturing device 110 and the second image capturing device 120 are used, the first image capturing device 110 and the second image capturing device 120 have to execute a calibration procedure to obtain an internal parameters matrix, a rotation matrix and a displacement matrix of the first image capturing device 110 and the second image capturing device 120.

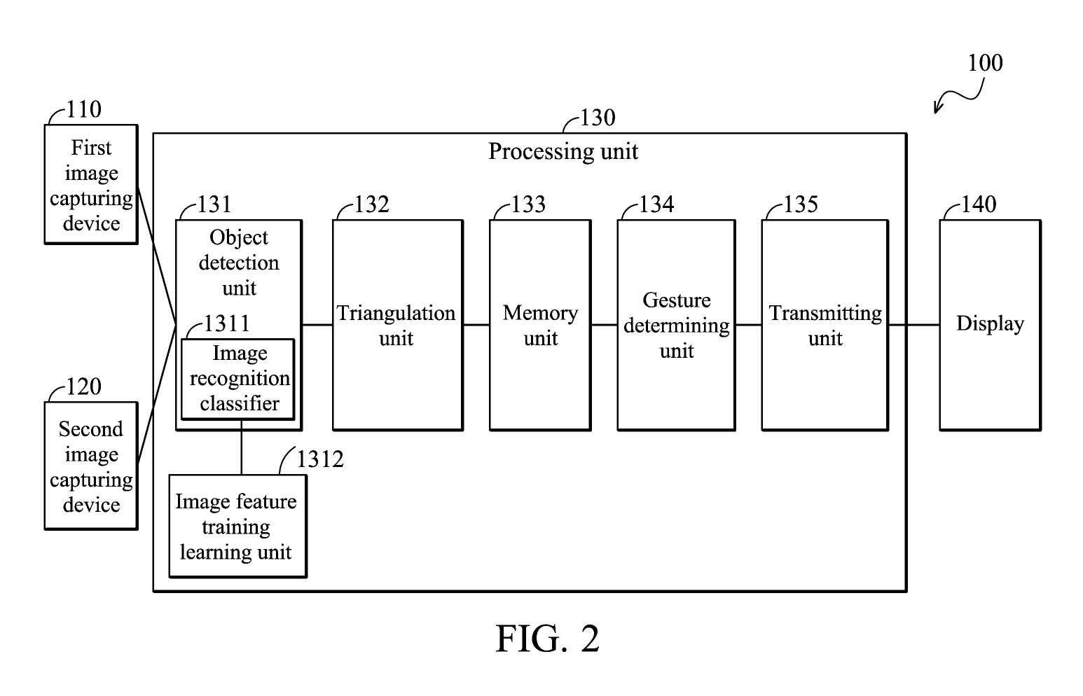

FIG. 2 is a block diagram of a gesture input system 100 according to an embodiment of the present invention. The processing unit 130 is coupled to the first image capturing device 110, the second image capturing device 120 and the display 140. The processing unit 130 further comprises an object detection unit 131, a triangulation unit 132, a memory unit 133, a gesture determining unit 134 and a transmitting unit 135.

First, the object detection unit 131 comprises an image recognition classifier 1311. The image recognition classifier 1311 has to be pre-trained to learn an ability for recognizing features of the hand, wherein the image recognition classifier 1311 can use an image feature training learning unit 1312. For example, an Open CV software developed by Intel Corporation may be used. The Open CV uses a large number of the grayscale images of the hand and other grayscale images and executes offline training to pre-train and learn the ability for recognizing features of the hand according to a support vector machine or Adaboost technology. It is noteworthy to note that the object detection unit 131 only uses grayscale images, therefore different light sources, color temperatures, and colors (for example, white light of a fluorescent, yellow light of a tungsten filament lamp, sun light) do not affect the object detection unit 131 detecting the hand with different skin colors varied with the light of an environment. In addition, a large number of the grayscale images of the hand and other grayscale images are pre-trained in the embodiment. The image of the hand can be a palm image, where all five fingers are spread apart, or can also be a first image where all five fingers are clenched. However, in addition to the hand mentioned above, a person of ordinary skill in the art can pre-train the image feature training learning unit 1312 to learn other facial features or other extremities.

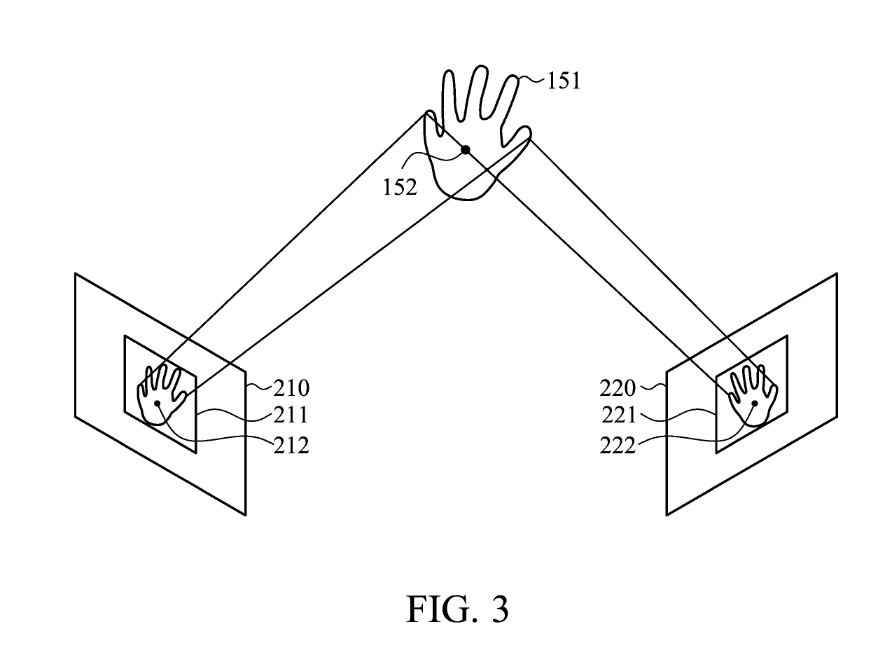

First, the user 150 waves a hand 151, and the first image capturing device 110 and the second image capturing device 120 start to capture the grayscale images of the front object. Then, the image recognition classifier 1311, which has be pre-trained, compares the grayscale images of the front object with the grayscale images of the hand. When the image recognition classifier 1311 recognizes that the front object is a hand, the first image capturing device 110 and the second image capturing device 120 capture the grayscale images of the hand 151 of the user 150, and generate a first grayscale image 210 and a second grayscale image 220 of the hand, respectively (as shown in FIG. 3). Then, according to the image information of the first grayscale image 210 and the second grayscale image 220, the sliding window 211 and the sliding window 212 are used to capture the areas in which the hand is imaged in the first grayscale image 210 and the second grayscale image 220. The center of gravity of the first grayscale image 210 and the second grayscale image 220 are selected as the imaging positions of the hand 151, for example, the first grayscale image 212 and the second imaging position 222 shown in FIG. 3. Note that in the embodiment, the center of gravity of the sliding window is selected as the imaging position of the hand. However, a person of ordinary skill in the art can use a center of a shape, a center of a geometry, or other points of the image to represent two dimensional coordinates of the object.

Then, according to the first grayscale image 212, the second imaging position 222 and the internal parameters matrix, the rotation matrix and the displacement matrix of the first image capturing device 110 and the second image capturing device 120, the triangulation unit 132 uses a triangulation algorithm to calculate a three-dimensional coordinates of the center 152 of gravity of the imaging position of the hand 151 at a certain time point. Reference may be made to the Multiple View Geometry in Computer Vision, Second Edition, Richard Hartley and Andrew Zisserman, Cambridge University Press, March 2004, for the detailed technical description about the triangulation algorithm.

The memory unit 133 records a motion track of the center 152 of gravity of the hand 151 in the three-dimensional space coordinate. The gesture determining unit 134 recognizes the motion track and generates a gesture command corresponding to the recognized motion track. Finally, the gesture determining unit 134 transmits the gesture command to the transmitting unit 135. The transmitting unit 135 transmits the gesture command to the display 140 to control the corresponding component in the display 140. For example, the corresponding component is a computer cursor or a graphics user interface (GUI).

It should be noted that each unit in the processing unit described above in the present invention is a separate component. However, these components can be integrated together to reduce the number of components in the processing unit.

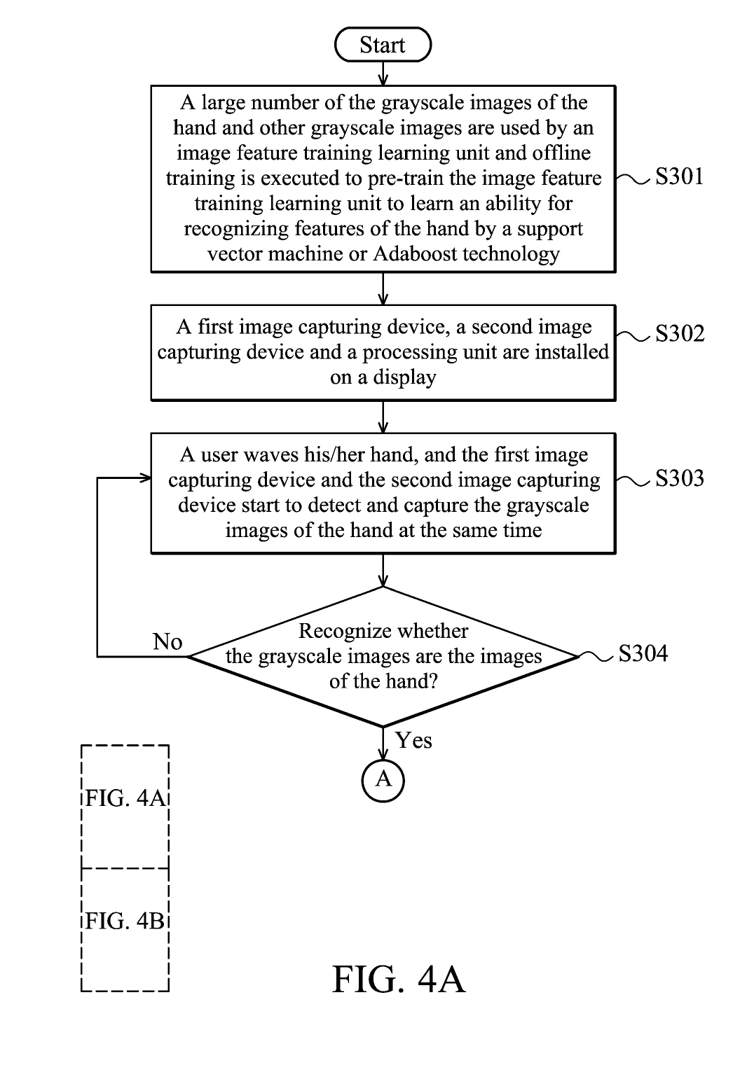

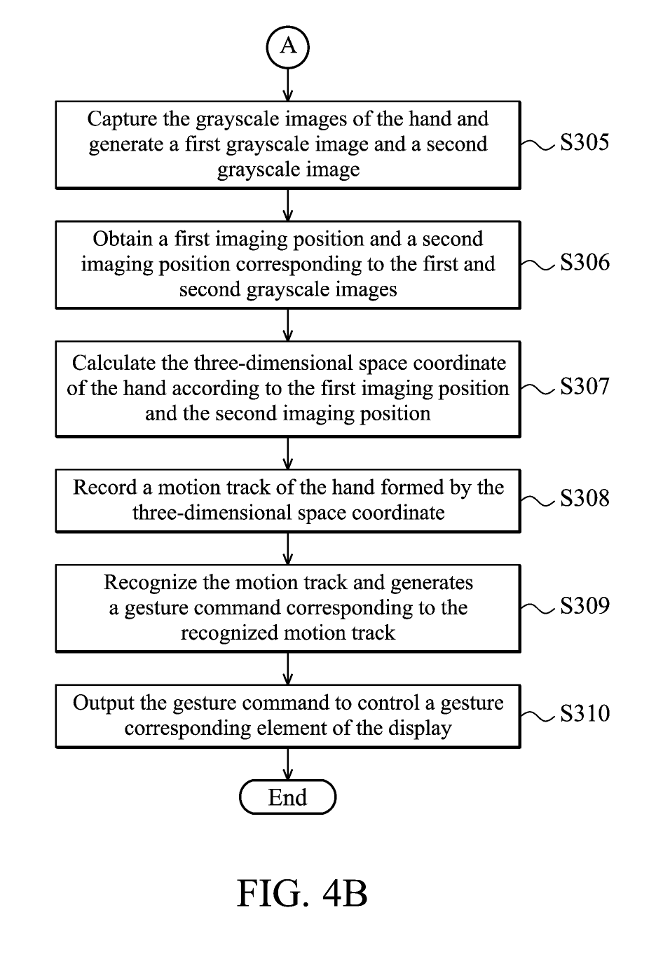

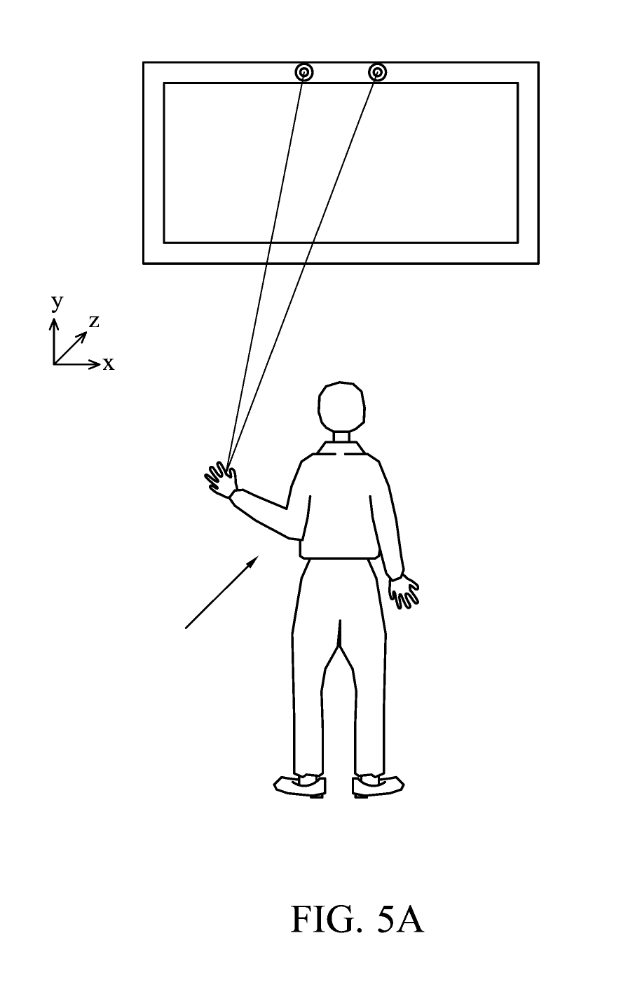

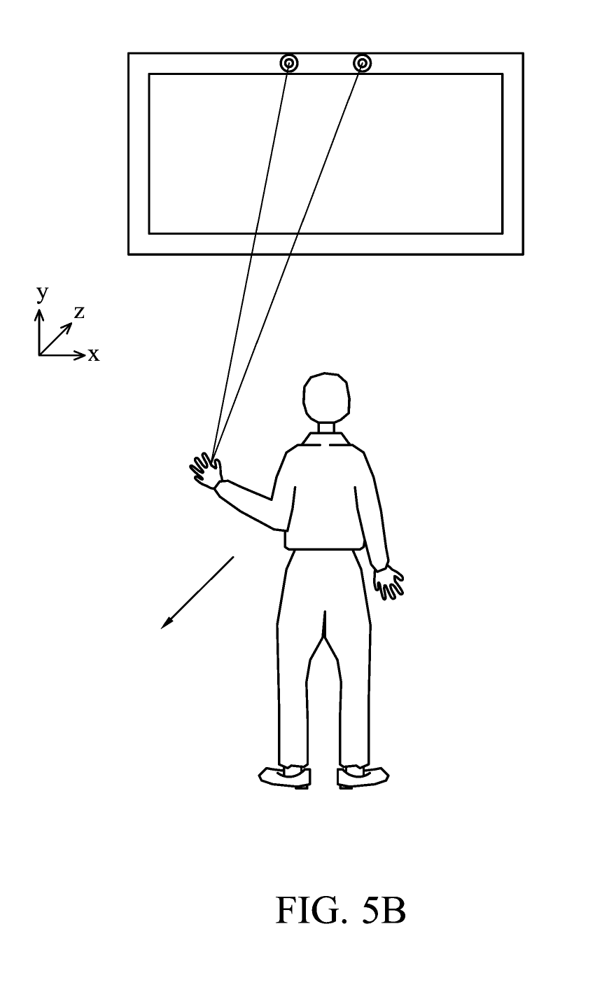

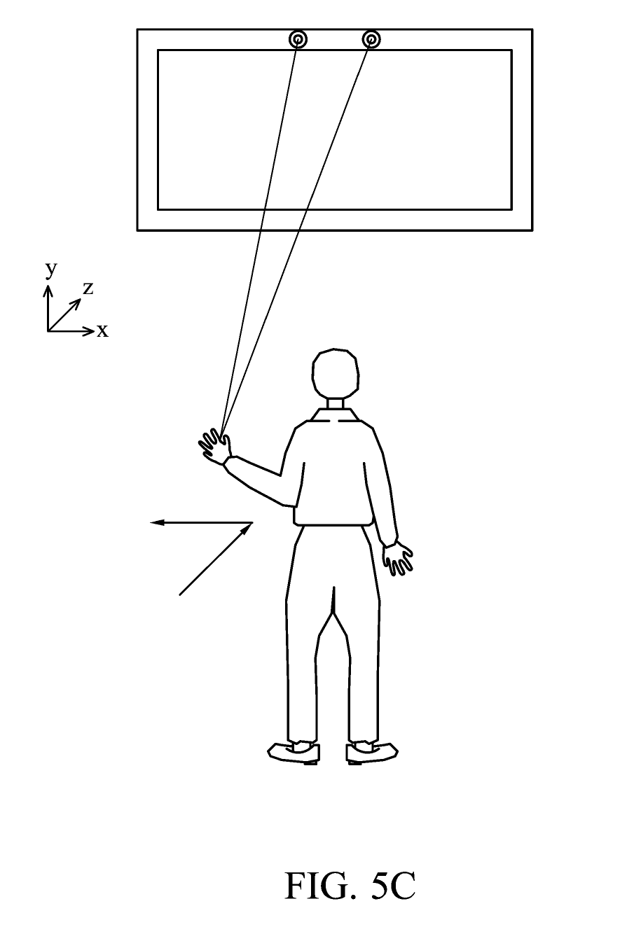

FIGS. 4A˜4B are flow diagrams illustrating the gesture input method used in the gesture input system according to an embodiment of the present invention.

Referring to FIGS. 1˜3, first, in step S301, a large number of the grayscale images of the hand and other grayscale images are used by an image feature training learning unit and offline training is executed to pre-train the image feature training learning unit to learn an ability for recognizing features of the hand by a support vector machine or Adaboost technology.

In step S302, a first image capturing device, a second image capturing device and a processing unit are installed on a display. In step S303, a user waves his/her hand, and the first image capturing device and the second image capturing device start to detect and capture the grayscale images of the hand at the same time. Then, in step S304, the pre-trained image recognition classifier of the object detection unit recognizes whether the grayscale images are the images of the hand. When the grayscale images are not the images of the hand, step S303 is performed and the first image capturing device and the second image capturing device continue to detect the object. In step S305, when the grayscale images are the images of the hand, the first image capturing device and the second image capturing device capture the grayscale images of the hand and generate a first grayscale image and a second grayscale image, respectively. In step S306, the object detection unit obtains a first imaging position and a second imaging position corresponding to the first and second grayscale images according to the first grayscale image and the second grayscale image. In step S307, the triangulation unit calculates the three-dimensional space coordinate of the hand according to the first imaging position and the second imaging position. In step S308, the memory unit records a motion track of the hand formed by the three-dimensional space coordinate. In step S309, the gesture determining unit recognizes the motion track and generates a gesture command corresponding to the recognized motion track. Finally, in step S310, the transmitting unit outputs the gesture command to control a gesture corresponding element of the display.

FIGS. 5A˜5C are schematic diagrams illustrating applications of the gesture input method and system according to an embodiment of the present invention. A user can input different gesture commands which correspond to different motion tracks into the gesture determining unit 134 in advance. For example, reference may be made to Table 1, but Table 1 are not limited thereto.

TABLE 1

| Motion Track | Gesture Command |
|---|---|
| Pull | Select |
| Push | Move |
| Pull + Push left | Delete |

As shown in FIG. 5A, a user can input a motion track “Push” by his/her hand (the user's hand is moved from the user to the display along the z-axis direction) to perform a gesture command “Select” to control the gesture corresponding element to select a certain content shown in the display. As shown in FIG. 5B, the user can input a motion track “Pull” by his/her hand (the user's hand is moved from the display to the user along the z-axis direction) to perform a gesture command “Move” to move a certain content displayed in the display. As shown in FIG. 5C, the user can input a motion track “Pull+Push left” by his/her hand (the user's hand is moved from the user to the display along the z-axis direction, and then shifted left along the x-axis direction) to perform a gesture command “Delete” to delete a certain content shown in the display

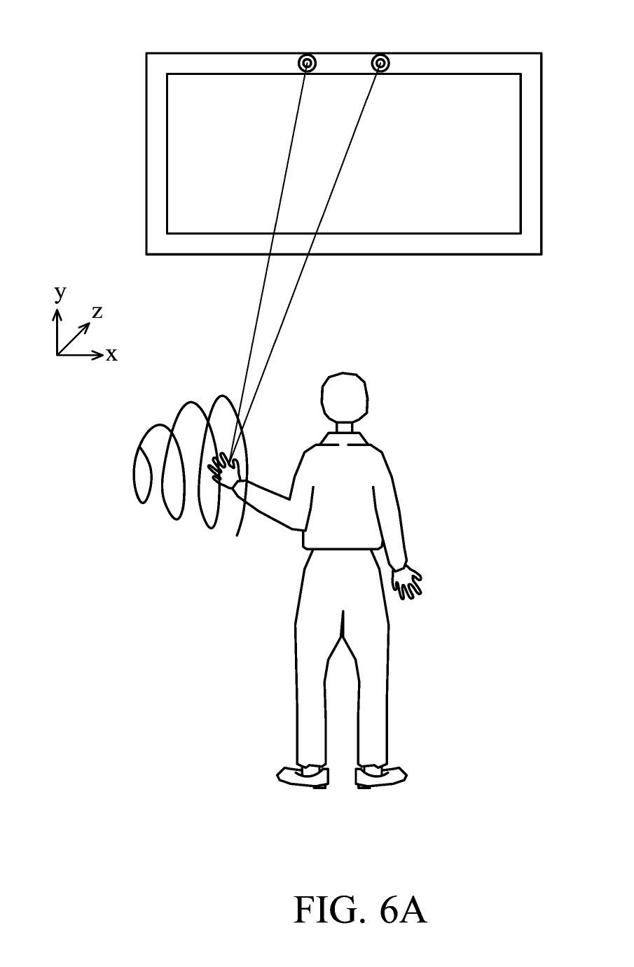

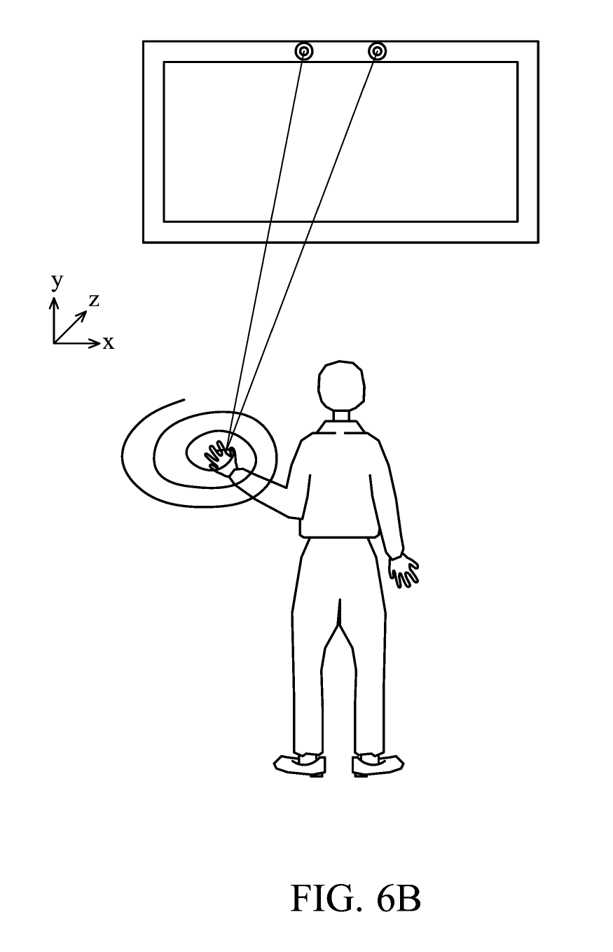

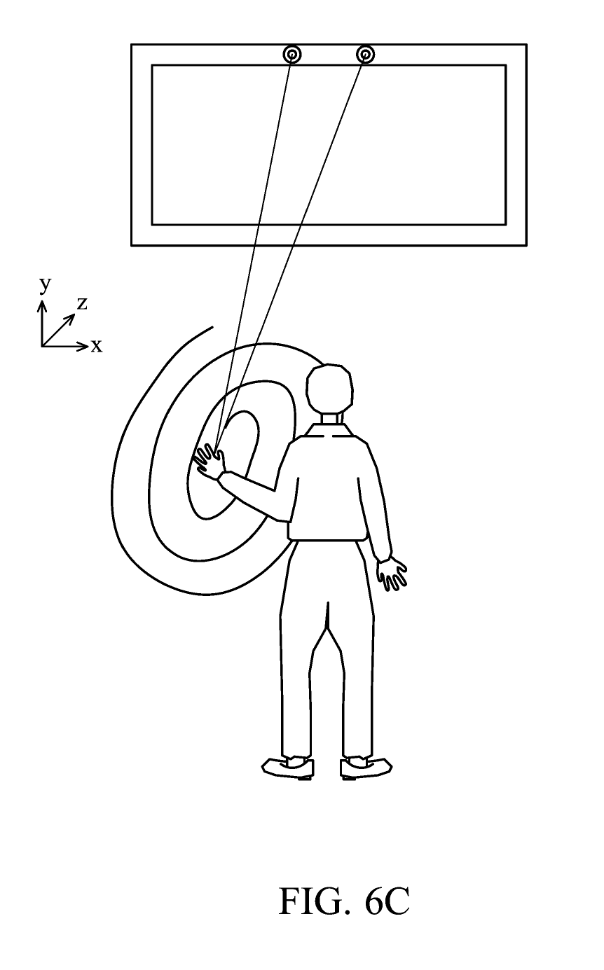

FIGS. 6A˜6C are schematic diagrams illustrating applications of the gesture input method and system according to an embodiment of the present invention. The user can further input a more complex gesture command. As shown in FIGS. 6A˜6C, the user inputs complex motion tracks by his/her hand, such as “Plane rotation”, “Three-dimensional tornado” and so on, to perform different gesture commands. The gesture input method and system in the invention can further use more complicated gestures to do more applications in a friendly manner for the user.

Therefore, through the gesture input method and system in the present invention, three-dimensional coordinates and the motion track of an object can be obtained quickly by using the imaging positions corresponding to the object according to the grayscale images captured by the first image capturing device and the second image capturing device. In addition, the manner in which the object detection unit can be pre-trained to learn the ability for recognizing the features of the hand is adapted in the present invention, and therefore the interference of external ambient light, color temperatures, and colors do not affect the gesture input method and system. Some of the advantages of the gesture input system in the invention are that there is no complicated probability statistical analysis and depth mapping model adapted, like in the prior art, and the first and the second image capturing device can be placed in the position with an appropriate angle and be calibrated in advance instead of being placed in parallel. Furthermore, cost is low and the mechanism of the gesture input system is light, thin, short and small, and therefore the gesture input system can be easily integrated with other devices. Moreover, the computational load that the gesture input system requires is low to facilitate realizing the gesture input system in embedded platforms.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gesture input method, used in a gesture input system to control a content of a display, wherein the gesture input system comprises a first image capturing device, a second image capturing device, an object detection unit, a triangulation unit, a memory unit, a gesture determining unit, and a display, the gesture input method comprising:
capturing, by the first image capturing device, a hand of a user and generating a first grayscale image;
capturing, by the second image capturing device, the hand of the user and generating a second grayscale image;
detecting, by the object detection unit, the first and second grayscale images to obtain a first imaging position and a second imaging position corresponding to the first and second grayscale images, respectively;
calculating, by the triangulation unit, a three-dimensional space coordinate of the hand according to the first imaging position and the second imaging position;
recording, by the memory unit, a motion track of the hand formed by the three-dimensional space coordinate; and
recognizing, by the gesture determining unit, the motion track and generating a gesture command corresponding to the recognized motion track.

2. The gesture input method as claimed in claim 1, wherein the method further comprises:
outputting, by a transmitting unit, the gesture command to control a gesture corresponding element of the display.

3. The gesture input method as claimed in claim 1, wherein the object detection unit detects the first imaging position of the hand in the first grayscale image and the second imaging position of the hand in the second grayscale image by using a sliding window, respectively.

4. The gesture input method as claimed in claim 1, wherein the triangulation unit calculates the three-dimensional space coordinates of the hand according to a plurality of internal parameters, a rotation matrix, a displacement matrix of the first image capturing device and the second image capturing device, and the first imaging position and the second imaging position.

5. The gesture input method as claimed in claim 1, when the first image capturing device and the second image capturing device capture the first grayscale image and the second grayscale image, further comprising:
recognizing, by the object detection unit, whether object images captured by the first image capturing device and the second image capturing device are the grayscale images of the hand.

6. The gesture input method as claimed in claim 5, when the first image capturing device and the second image capturing device capture the first grayscale image and the second grayscale image, further comprising:
recognizing, by an image recognition classifier of the object detection unit, the grayscale images of the hand of the user.

7. The gesture input method as claimed in claim 6, when the image recognition classifier recognizes the grayscale images of the hand of the user, further comprising:
using, by an image feature training learning unit, a large number of the grayscale images of the hand and other grayscale images and executing offline training to pre-train the image feature training learning unit to learn an ability for recognizing features of the hand according to a support vector machine or Adaboost technology.

8. A gesture input system, coupled to a display, comprising:
a first image capturing device, configured to capture a hand of a user and generate a first grayscale image;
a second image capturing device, configured to capture a hand of a user and generate a second grayscale image; and
a processing unit, coupled to the first image capturing device and the second image capturing device, comprising:
an object detection unit, coupled to the first image capturing device and the second image capturing device and configured to detect a first grayscale image and a second grayscale image to obtain a first imaging position and a second imaging position corresponding to the first and second grayscale images, respectively;
a triangulation unit, coupled to the object detection unit and configured to calculate a three-dimensional space coordinate of the hand according to the first imaging position and the second imaging position;
a memory unit, coupled to the triangulation unit and configured to record a motion track of the hand formed by the three-dimensional space coordinate; and
a gesture determining unit, coupled to the memory unit and configured to recognize the motion track and generate a gesture command corresponding to the recognized motion track.

9. The gesture input system as claimed in claim 8, wherein the processing unit further comprises:
a transmitting unit, coupled to the gesture determining unit and configured to output the gesture command to control a gesture corresponding element of the display.

10. The gesture input system as claimed in claim 8, wherein the object detection unit detects the first imaging position of the hand in the first grayscale image and the second imaging position of the hand in the second grayscale image by using a sliding window, respectively.

11. The gesture input system as claimed in claim 8, wherein the triangulation unit calculates the three-dimensional space coordinates of the hand according to a plurality of internal parameters, a rotation matrix, a displacement matrix of the first image capturing device and the second image capturing device, and the first imaging position and the second imaging position.

12. The gesture input system as claimed in claim 8, wherein the object detection unit detects the first imaging position of the hand in the first grayscale image and the second imaging position of the hand in the second grayscale image by using a sliding window, further comprises:
an image recognition classifier, configured to recognize the grayscale images of the hand of the user.

13. The gesture input system as claimed in claim 12, wherein the image recognition classifier uses a large number of the grayscale images of the hand and other grayscale images to pre-train an image feature training learning unit and learn an ability for recognizing features of the hand according to a support vector machine or Adaboost technology.
